(19) United States
(12) Patent Application Publication
(10) Pub. No.: US 2010/0198660 A1
(43) Pub. Date: Aug. 5, 2010

(54) SUBCONTRACTOR COMPLIANCE MEASUREMENT

(75) Inventors: Lisa Armstrong, Lincolnton, NC (US); Jeffrey Hipple, Huntersville, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, CHARLOTTE, NC (US)

(21) Appl. No.: 12/362,545

(22) Filed: Jan. 30, 2009

(51) Int. Cl. G06Q 10/00

(52) U.S. Cl. 705/11

(57) ABSTRACT

A subcontractor compliance measurement system and methods are disclosed. Tiering criteria are applied to each subcontractor from among a plurality of subcontractors. The tiering criteria are indicative of situational risk. The tiering criteria are used to calculate a risk score for the subcontractor. The subcontractor is then assigned to a tier using a numerical value of the risk score, wherein the tier is indicative of a compliance risk monitoring posture for the subcontractor. Contractors in a high-risk tier are then monitored with tools such as a heat map and a validation tool so that risk can be mitigated. Contract compliance metrics for subcontractors can be displayed, and scoring for the primary contractor can be derived from heat map data for the subcontractors.

### BACKGROUND

Operation of a successful business today requires the ability to collaborate with companies throughout the world. Further, oftentimes today's businesses are of such a complex nature that numerous suppliers of goods and services are utilized by a single business. Risk is an important factor to be considered whenever any kind of interaction is implemented between a contracting business and a supplier. Risk factors that are of particular concern when contracting with suppliers of goods and services include any factors that could expose a business to loss or theft, as suppliers often have direct access to proprietary business systems and information. Businesses therefore tend to expend valuable resources managing and mitigating risk factors inherent to supplier relationships. However, such resources tend to be allocated subjectively and don't tend to take into account all of the factors that may play into a multi-faceted enterprise-supplier relationship.

Suppliers may present risks to the business contracting with them in a number of different ways. One way in which a supplier presents risk is through subcontractors of the supplier. It is difficult to compare one supplier to another when many different variables must be taken into consideration and even more difficult when the supplier uses many subcontractors that often work independently.

### SUMMARY

Embodiments of the present invention provide a system and method for automatically prioritizing subcontractors according to various risk factors. High priority subcontractors are given a heightened compliance risk monitoring posture. Such subcontractors are then monitored with tools such as a heat map and a validation tool so that risk can be mitigated. Contract compliance metrics for subcontractors can be displayed, and scoring for the primary supplier can be derived from heat map data for the subcontractors.

Example embodiments of the invention include a computerized method of monitoring subcontractor compliance risk. The method further includes assaying tiering criteria for a subcontractor from among a plurality of subcontractors. The tiering criteria are indicative of situational risk. The subcontractor is scored by using results of the assaying for each of the tiering criteria to calculate a risk score for the subcontractor. The subcontractor is then assigned to a tier using the numerical value of the risk score, wherein the tier is indicative of a compliance risk monitoring posture for the subcontractor.

In some embodiments tiering criteria are assayed by receiving input regarding answers to a plurality of risk-related questions. For each subcontractor whose risk score is greater than a specified value, contract element values can then be aggregated into a plurality of contract compliance metrics. A heat map can be displayed for the plurality of contract compliance metrics for the plurality of subcontractors, wherein the heat map contains visual highlighting based on a value of an overall contract compliance metric. For example, background color can be used. A heat map may be validated by sending heat map data to a validation tool.

Embodiments of the invention are implemented via either a stand-alone instruction execution platform or such a platform interconnected with other platforms or data stores by a network, such as a corporate intranet, a local area network, or the Internet. A computer program product or computer program products contain computer programs with various instructions to cause the hardware to carry out, at least in part, the methods and processes of embodiments of the invention. Data sets may include contract element data, contract compliance metrics, heat maps, and data used for validation. These data sets may be stored locally or accessed over the network. Dedicated software can be provided to implement an embodiment of the invention, or alternatively, a spreadsheet program can be used to implement embodiments of the invention. In either case a user screen is operable to receive appropriate input and to provide output.

### BRIEF DESCRIPTION OF THE DRAWINGS

FIG. 1 is a flowchart showing the tiering process according to example embodiments of the present invention.

FIG. 2 is a flowchart illustrating how contract compliance metrics are obtained and used to generate a heat map according to example embodiments of the present invention.

FIG. 3 illustrates a portion of an example heat map that might be generated by an embodiment of the present invention.

FIG. 4 is a system block diagram illustrating apparatus and an operating environment for carrying out at least some embodiments of the present invention.

### DETAILED DESCRIPTION OF THE INVENTION

The following detailed description of embodiments refers to the accompanying drawings, which illustrate specific embodiments of the invention. Other embodiments having different structures and operation do not depart from the scope of the present invention.

The following description is based on an exemplary implementation of an embodiment of the invention in a financial institution, but it is understood that the present invention could be useful in many different types of businesses and the example herein is not intended to limit the use of the invention to any particular industry. The term “financial institution” refers to an institution that acts as an agent to provide financial services for its clients or members. Financial institutions generally, but not always, fall under financial regulation from a government authority. Financial institutions include, but are not limited to, banks, building societies, credit unions, stock brokerages, asset management firms, savings and loans, money lending companies, insurance brokerages, insurance underwriters, dealers in securities, and similar businesses.

The present invention can be embodied in computer software or a computer program product. An embodiment may include a spreadsheet program and may also include appropriate macro programs, algorithms, or plug-ins. An embodiment may also consist of a custom-authored software application for any of various computing platforms. One specific example discussed herein involves the use of a Windows™ personal computing platform running Microsoft Excel™ spreadsheet software. It cannot be overemphasized that this embodiment is an example only. It will also be readily understood that the inventive concepts described herein can be adapted to any type of hardware and software platform using any operating system including those based on Unix™ and Linux. In any such embodiments, the instruction execution or computing platform in combination with computer program code instructions form the means to carry out the processes of the invention.

Embodiments of the present invention can find use in a global supply chain management program for an enterprise such as a bank, manufacturing company, insurance company, or any other business. Such a management program can constitute a framework of governance, processes and tools to manage enterprise supplier risk connected with the use of subcontractors annually, or at any other frequency desired.

Risk may need to be managed to internal standards developed by the enterprise. Additionally, risk may need to be managed due to external regulations and standards. For example, a financial institution such as a bank in the United States may need to manage risk to meet requirements imposed by the government, such as those specified in statutes such as the USA Patriot Act, the Gramm-Leach-Bliley Act, and the Sarbanes-Oxley Act.

Banks in the United States are also regulated by the Office of the Comptroller of the Currency (OCC) and need to mitigate risks imposed by having to comply with OCC regulations. The focus of the OCC regulations is on safety and soundness. For a financial enterprise, operational risk is a critical concern. Operational risk is the risk of direct and indirect loss due to people, processes, technology, regulation, external events, execution, or reputation.

Supplier management is concerned with one form of external events risk. External events risk is the risk from outside the businesses' normal span of control. Events risk may include risks posed by vendors, alliances, and service providers. Third-party supplier services can be considered an extension of an enterprise's internal operations. It is the enterprise's responsibility to ensure the quality of operations and controls provided by a supplier and the supplier's subcontractors. As used here, the term “enterprise” can be used to refer to the primary business that has entered into a contractual agreement with a “supplier” for goods or services. A “supplier” is a business that provides goods or services. A “subcontractor” is an entity hired by a supplier. A subcontractor does not have a direct contractual agreement with the contractor. It should be noted that a subcontractor in some cases could be an individual.

The automated tools described herein to manage subcontractor compliance can be used, for example, by a supplier manager of an enterprise. Subcontractor compliance can deal with issues such as personnel background checks and certificates of insurance. According to example embodiments of the invention, a tiering methodology is used to prioritize the highest spend and riskiest subcontractors of an enterprise for contract monitoring. Risk elements that can be monitored in example embodiments of the invention include those related to confidentiality and information protection, personnel, business continuity, audit requirements, finance and insurance. Subcontractor performance can also be measured.

In a typical enterprise, a supplier manager would be assigned by a business unit, or so-called “line of business” (LOB). A supplier manager can serve as a liaison between the supplier and the contracting enterprise. The supplier manager can define supplier service level agreements and corresponding performance metrics. The supplier manager may maintain an understanding of the terms and conditions of the contract between the enterprise and the supplier and manage the supplier to all terms and conditions of the contract. The supplier manager also often drives mitigation actions, resolves and/or escalates issues and monitors the quality and timeliness of deliverables. The term, “supplier manager” is not meant to be limiting. Any person associated with the enterprise who performs these or similar functions can be considered a “supplier manager” for purposes of implementing an embodiment of the invention, irrespective of the person's actual title as an associate of the enterprise.

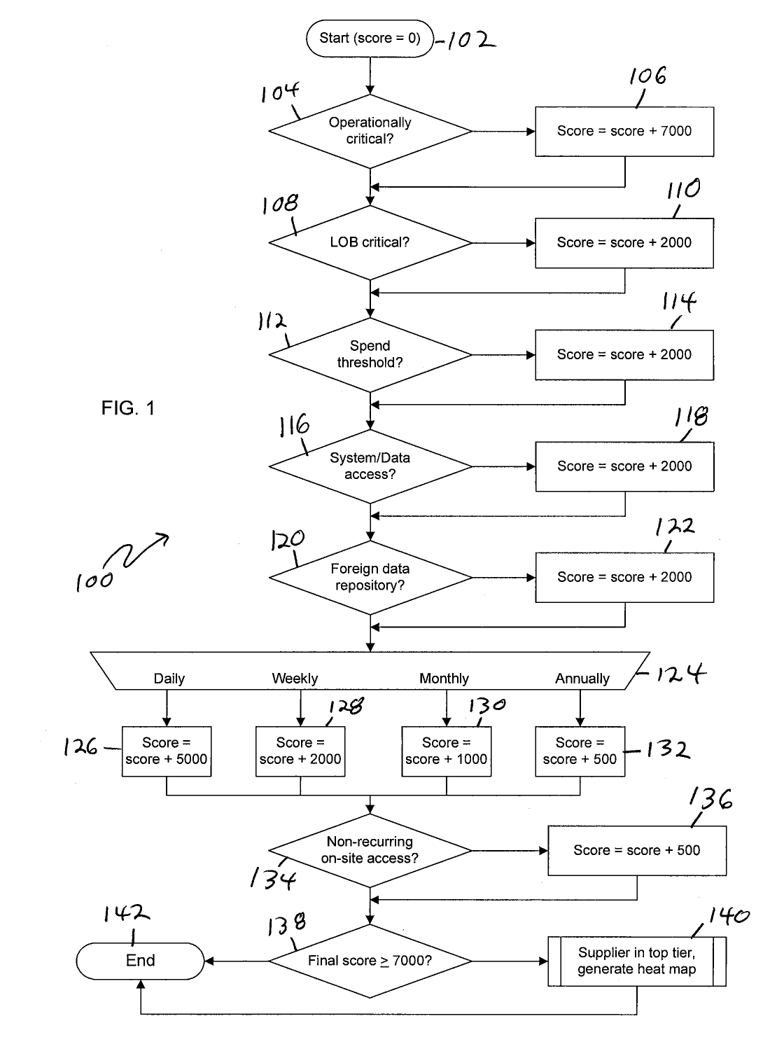

FIG. 1 is a flowchart illustrating a tiering process according to at least some embodiments of the present invention. Subcontractors are tiered by assaying (evaluating) tiering criteria indicative of situation risk. In this example, subcontractors are placed into two tiers, an upper tier, which might be called “tier 1” for subcontractors who obtain a risk score of 7000 or greater, and a lower tier for other subcontractors. Like most flowcharts, FIG. 1 presents process 100 as a series of process or sub-process blocks. At block 102, the process begins, and the risk score is set to zero. At block 104, a determination is made as to whether the subcontractor is operationally critical to the enterprise as a whole. If the subcontractor is operationally critical at block 104, the numerical value 7000 is added to the risk score at block 106. At block 108, a determination is made as to whether the subcontractor is critical to a line of business within the enterprise. If the subcontractor is critical to a line of business at block 108, the numerical value 2000 is added to the risk score at block 110. At block 112, a determination is made as to whether funds expended for the subcontractor's services meet a specified annual (or other periodic) threshold. If the spend threshold is met at block 112, the numerical value 2000 is added to the risk score at block 114. A supplier manager or other management personnel within an enterprise implementing an embodiment of the invention can set an appropriate spend threshold for a specific business situation. For a very large company in the financial services business, a spend threshold of 3.5 million dollars has been found to be appropriate.

Still referring to FIG. 1, at block 116, a determination is made as to whether the subcontractor has direct access to the data processing systems and thus the stored data of the enterprise. If the subcontractor has such access at block 116, the numerical value 2000 is added to the risk score at block 118. At block 120, a determination is made as to whether the subcontractor makes use of a foreign data repository. If the subcontractor does make use of a foreign data repository at block 120, the numerical value 2000 is added to the risk score at block 122. It should be noted that in example embodiments, the determinations referred to above, and referred to subsequently, can be made by receiving user input, or accessing data from a database or data set that contains answers to questions related to these situational risks. Multiple choice and/or yes/no questions can be used to gather input for both subcontractor tiering and to gather information on contract elements and contract compliance metrics as described later. Such multiple-choice and/or yes/no questions can provide an interface between a user, such as a supplier manager, and the automated, sophisticated risk analysis underlying the software tool implementing an embodiment of the invention.

Staying with FIG. 1, at block 124, a determination is made as to what level of recurring on-site access the subcontractor's personnel have to the enterprise's physical facilities. If the access is daily, the value 5000 is added to the risk score at block 126. If the access is weekly, the value 2000 is added to the risk score at block 128. If the access is monthly, the value 1000 is added to the risk score at block 130. If the access is annual, the value 500 is added to the risk score at block 132. At block 134, a determination is made as to whether access is non-recurring. If so, the value 500 is added to the risk score at block 136. If there is no access, no change is made to the risk score at any of blocks 126, 128, 130, 132 or 136. A determination is made at block 138 as to whether the risk score is greater than or equal to a specified threshold value. In this example embodiment this value is 7000. If the risk score is greater than or equal to that value at block 138, a heat map is generated at block 140. Process 100 of FIG. 1 ends at block 142.

It should be noted that although the example presented in FIG. 1 sorts subcontractors into two tiers, an embodiment could be implemented in which subcontractors are sorted into a larger number of tiers. As an example, a methodology could be used where 7000 still serves as the cutoff score for the highest risk tier, but another cutoff score of 4000 is provided, resulting in three tiers. As another example, cutoff scores of 7000, 5000, and 3000 could be used, resulting in four tiers. Such an embodiment would enable differing levels of risk monitoring as appropriately dictated by a tier into which a subcontractor falls.

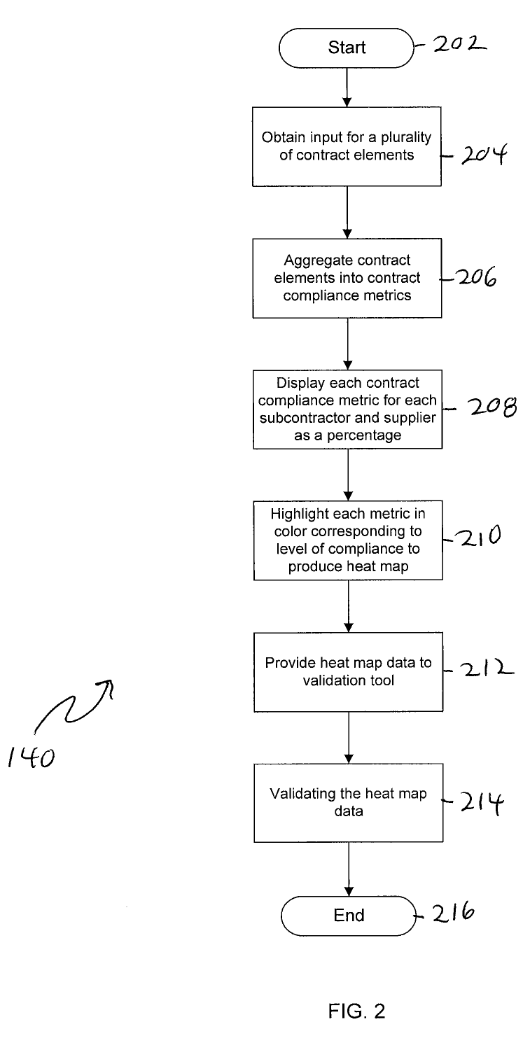

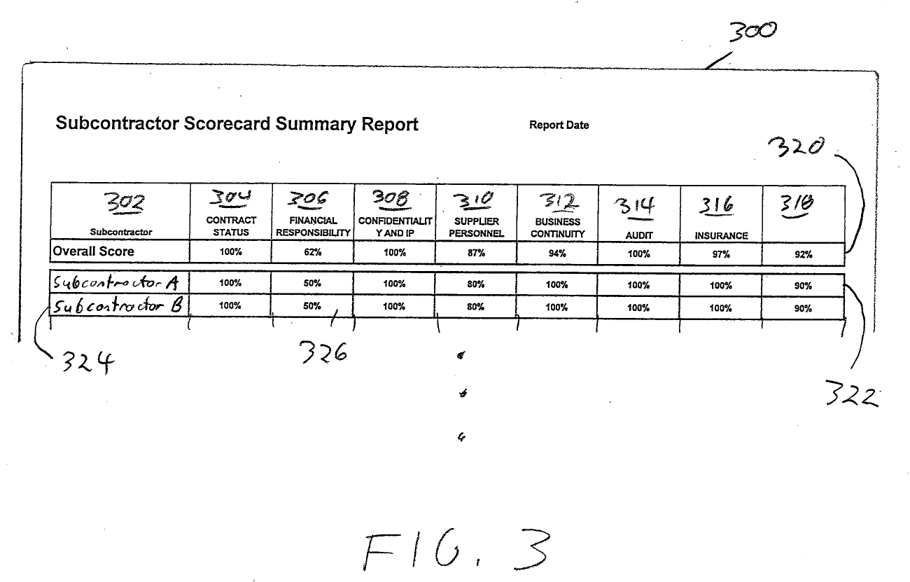

FIG. 2 is a flowchart illustrating heat-mapping process 140 from FIG. 1 in further detail. In example embodiments of the invention, heat mapping forms at least a portion of the heightened compliance risk monitoring posture for higher risk subcontractors. The process of generating a heat map for the highest risk tier of subcontractors makes use of contract elements and contract compliance metrics. Contract elements are connected with specific clauses and/or specific status information with respect to the contract between the enterprise and the supplier or specific information about the performance of the contract. Contract elements can be grouped together into a smaller number of related risk areas based on the general nature of the contract elements in the group. The values of these contract compliance metrics are the values that are ultimately displayed on the heat map that will be described in detail below in discussing FIG. 3.

As an example, in some embodiments, an overall contract compliance metric of contract status may reflect contract elements of whether a contract was ever put in place, and whether the expiration date of the contract has passed. A financial responsibility overall contract compliance metric may reflect contract elements such as a financial performance review and a financial viability status. A confidentiality and information protection (IP) metric may reflect contract elements such as whether the subcontractor has access to physical facilities, the frequency of access, whether access is limited to business hours and whether nondisclosure and/or confidentiality provisions are contained in the contract. A personnel overall contract compliance metric may include elements such as the percentage of background checks that are completed or current with respect to subcontractor personnel, the scope of the background checks, documentation of social security or other government identification numbers, drivers license information and status, and immigration information and status. An audit overall contract compliance metric reflects the right to audit subcontractors being contained in the contract. It should be noted that the “contract” as referred to with respect to contract metrics in example embodiments of the invention is the contract between the supplier and the subcontractor.

In at least some embodiments, a business continuity overall contract compliance metric simply reflects whether there is a business continuity plan in place. Essentially, this overall contract compliance metric only reflects a single element, representing the simplest case of identity between the overall contract compliance metric and the contract element. However, an insurance overall contract compliance metric might be very complex, reflecting coverage amounts, expiration dates and policy wording for certificates of insurance for general liability, automobile, umbrella, workers compensation, fidelity or crime bond, and professional liability coverage.

Turning to FIG. 2, process 140 begins at block 202. At block 204, information on various contract elements is obtained, in at least some embodiments, by user input through questions being presented in the manner previously described. In some embodiments this input may be stored and obtained from a database or data set. At block 206, the contract elements are aggregated into overall compliance metrics. This aggregation can be accomplished in various ways, for example, via Boolean logic or mathematical formula. Some specific examples of how to aggregate contract elements into some overall compliance metrics are discussed below with reference to FIG. 3.

Still referring to FIG. 2, to generate a heat map, each overall contract compliance metric for each subcontractor is displayed at block 208 as a percentage. A higher percentage indicates better compliance and lower risk. At block 210, each displayed percentage is visually highlighted. This visual highlighting can be accomplished in any number of ways. One way to visually highlight data is to use text and/or background color, for example green for a high level of compliance, yellow for a moderate level of compliance, and red for a low level of compliance, indicated that action needs to be taken. An example of a heat map using this type of highlighting scheme is presented in FIG. 3, discussed further below. At block 212 the data from the heat map can be provided to a validation tool and validated using the validation tool at block 214. Process 140 ends at block 216.

A validation tool as referred to above can simply display each overall contract compliance metric twice. For a given metric, in one field, the metric from the heat map is displayed. In another field, the same metric value using contract element information from a different source can be displayed. Since, the heat map is generated based on supplier responses, one way to verify the heat map is to calculate contract compliance metrics using contract element information provided by the supplier manager, or obtained from some other source within the enterprise. The supplier manager can input the information in some cases by physical verification, or reference to an independent data source. The two numbers for the metric can then be visually compared, or an automated calculation can be done and any differences can be in turn displayed and highlighted. For example, if the metric in question uses as a contract element the existence of a certain type of certificate of insurance, the supplier manager can physically verify the certificate by inspecting the appropriate paper file, and documenting the observation.

FIG. 3 is a top portion of an example heat map that might be generated according to an example embodiment of the present invention. Heat map screen portion 300 can also be referred to as a “Subcontractor Scorecard Summary Report” as indicated at the top of the screen. The heat map may be implemented as a Microsoft Excel spreadsheet. A date for the report/heat map can also be printed at the top. A column is provided on the heat map for a listing of the subcontractors in the heat map, namely, column 302. Columns are also provided for the contract compliance metrics previously discussed. Contract status is shown in column 304, finance or “financial responsibility” is shown in column 306, confidentiality and information protection (IP) in column 308, personnel in column 310, business continuity in column 312, the audit metric in column 314 and the insurance metric in column 316. Column 318 of heat map screen 300 shows overall scores.

Still referring to FIG. 3, overall score row 320 combines the metrics for all subcontractors of a given supplier. Subcontractor metrics are represented, each in their own row, for example, subcontractor A is shown in row 322 and subcontractor B is shown in row 324. Individual boxes, 326, show the relevant overall contract compliance metric as a percentage. In example embodiments, each box is visually highlighted with a background color according to the numerical percentage value of the overall contract compliance metric represented in the box. For example, a box can have a background color of green for a score of greater than 75%, yellow for a score of 50% to 75%, and red for a score of less than 50%.

As an example of using Boolean logic to aggregate contract element values into an overall contract compliance metric consider the contract status metric previously referred to. The contract elements are whether a contract was ever put in place with the subcontractor, and whether the contract is expired. The contract status overall compliance metric can be set to 100% (green) if the contract is in place and the contract has not expired, 50% (yellow) if the contract was put in place but it is now expired, or 0% (red) if no contract was ever put in place.

As another example of using Boolean logic to aggregate contract element values into an overall contract compliance metric consider the finance metric (“financial responsibility”) previously referred to. In this example, the contract elements are: whether a quarterly performance review of the subcontractor was conducted, and the annual financial viability status of the subcontractor. Assume further that the annual financial viability status can be one of good, moderate, or poor. These contract elements can be aggregated into an overall contract compliance metric as follows. If the subcontractor performance review is current and the financial viability status is good—then the metric score is 100%. If the subcontractor performance review is current and the financial viability status is moderate—then the metric score is 75%. If the subcontractor performance review is current and the financial viability status is poor—then the metric score is 50%. If the subcontractor performance review is not current and the financial viability status is good—then the metric score is 75%. If the subcontractor performance review is not current and the financial viability status is moderate—then the metric score is 50%. Finally, if the subcontractor performance review is not current and the financial viability status is poor—then the metric score is 0%. Supply management personnel of an enterprise can develop specific contract elements and metrics, as well as the logic to aggregate the elements, as appropriate for the specific situation of the enterprise.

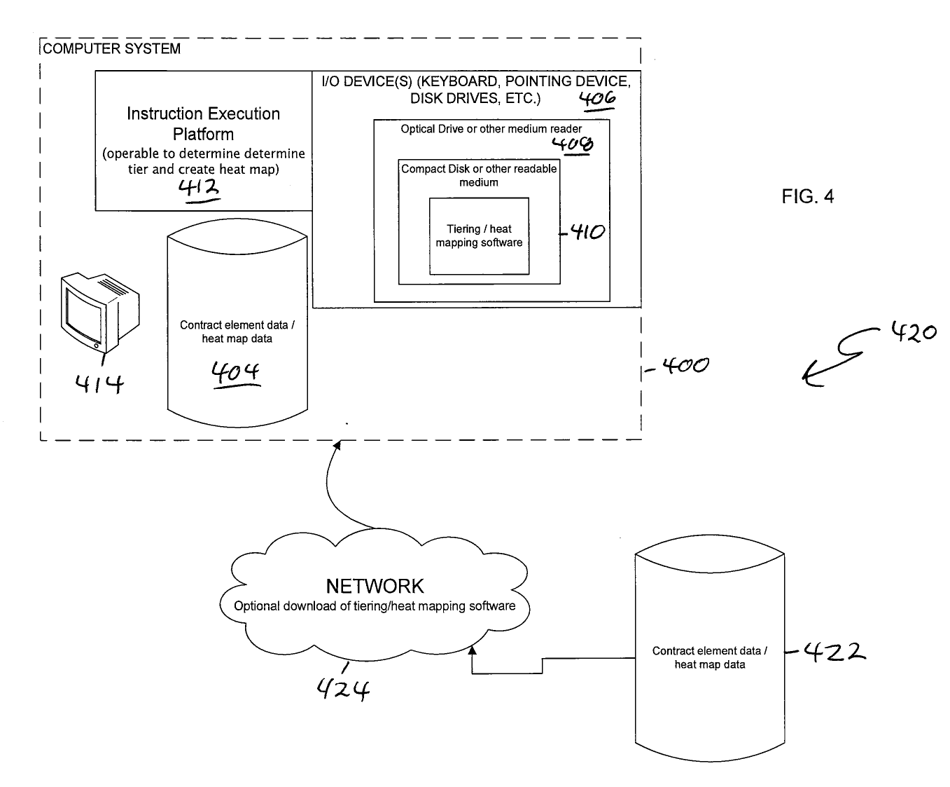

FIG. 4 is a system block diagram according to example embodiments of the invention. FIG. 4 actually illustrates two alternative embodiments of a system implementing the invention. System 400 can be a workstation or personal computer. System 400 can be operated in a “stand-alone” mode. The system includes a fixed storage medium, illustrated graphically at 404, for storing programs and/or macros which enable the use of an embodiment of the invention. In a stand-alone implementation of the invention, fixed storage 404 can also include the data sets which are necessary to implement an embodiment of the invention. In this particular example, the input/output devices 406 include an optical drive 408 connected to the computing platform for loading the appropriate computer program product into system 400 from an optical disk 410. The computer program product includes a computer program or programs with instructions or code for carrying out the methods of embodiments of the invention. Instruction execution platform 412 of FIG. 4 includes a microprocessor and supporting circuitry and can execute the appropriate instructions and display appropriate screens on display device 414.

FIG. 4 also illustrates another embodiment of the invention in which case the system 420 which is implementing the invention includes a connection to data stores 422, from which heat map data, and contract element data can be obtained. The connection to the data stores or appropriate databases can be formed in part by network 424, which can be an intranet, virtual private network (VPN) connection, local area network (LAN) connection, or any other type of network resources, including the Internet. Data sets can be local, for example on fixed storage 404, or stored on the network, for example in data store 422. Software to implement a tool to tier the subcontractor and generate heat maps can also optionally be downloaded via network 424.

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-readable storage medium having computer-usable program code embodied in the medium.

Any suitable computer usable or computer readable medium may be utilized to carry out the function of the computer readable media illustrated in FIG. 4. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the computer executable instructions stored in the computer readable memory produce an article of manufacture including instruction means which implement the function/act specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, action, or portion of code, which comprises one or more executable instructions or actions for implementing the specified logical function(s). It should also be noted that, in some alternative implementations, the functions noted described herein may occur out of the order presented, depending upon the functionality involved. It will also be noted that each block of the block diagrams and/or flowchart illustrations, and combinations of blocks in the block diagrams and/or flowchart illustrations, can be implemented by special purpose hardware-based systems or operators which perform the specified functions or acts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Additionally, comparative, quantitative terms such as “above”, “below”, “less”, “greater”, are intended to encompass the concept of equality, thus, “less” can mean not only “less” in the strictest mathematical sense, but also, “less than or equal to.”

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A computerized method of monitoring subcontractor compliance risk, the method comprising:
assaying tiering criteria for a subcontractor from among a plurality of subcontractors, the tiering criteria indicative of situational risk;
scoring the subcontractor by using results of the assaying for each of the tiering criteria to calculate a risk score for the subcontractor; and
assigning the subcontractor to a tier using a numerical value of the risk score, wherein the tier is indicative of a compliance risk monitoring posture for the subcontractor.

2. The method of claim 1 wherein the assaying of the tiering criteria further comprises receiving input regarding answers to a plurality of risk-related questions.

3. The method of claim 1 further comprising aggregating contract element values for the plurality of subcontractors into a plurality of contract compliance metrics when the risk score is greater than a specified threshold value.

4. The method of claim 3 further comprising displaying a heat map for the plurality of contract compliance metrics for the plurality of subcontractors, wherein the heat map contains visual highlighting based on a value of an overall contract compliance metric.

5. The method of claim 4 further comprising validating the heat map by providing heat map data to a validation tool.

6. The method of claim 2 further comprising:
aggregating contract element values for the plurality of subcontractors into a plurality of contract compliance metrics when the risk score is greater than specified threshold value; and
displaying a heat map for the plurality of contract compliance metrics for the plurality of subcontractors, wherein the heat map contains visual highlighting based on a value of a contract compliance metric.

7. The method of claim 6 further comprising validating the heat map by providing heat map data to a validation tool.

8. A computer program product comprising a computer-readable storage medium having computer-readable program code embodied therein, the computer-readable program code being executable to implement a method of monitoring subcontractor compliance risk, the method comprising:
assaying tiering criteria for a subcontractor from among a plurality of subcontractors, the tiering criteria indicative of situational risk;
scoring the subcontractor by using results of the assaying for each of the tiering criteria to calculate a risk score for the subcontractor; and
assigning the subcontractor to a tier using a numerical value of the risk score, wherein the tier is indicative of a compliance risk monitoring posture for the subcontractor.

9. The computer program product of claim 8 wherein the assaying of the tiering criteria further comprises receiving input regarding answers to a plurality of risk-related questions.

10. The computer program product of claim 8 wherein the method further comprises aggregating contract element values for the plurality of subcontractors into a plurality of contract compliance metrics when the risk score is greater than a specified threshold value.

11. The computer program product of claim 10 wherein the method further comprises displaying a heat map for the plurality of contract compliance metrics for the plurality of subcontractors, wherein the heat map contains visual highlighting based on a value of an overall contract compliance metric.

12. The computer program product of claim 11 wherein the method further comprises validating the heat map by providing heat map data to a validation tool.

13. The computer program product of claim 9 further wherein the method further comprises:
aggregating contract element values for the plurality of subcontractors into a plurality of contract compliance metrics when the risk score is greater than specified threshold value; and
displaying a heat map for the plurality of contract compliance metrics for the plurality of subcontractors, wherein the heat map contains visual highlighting based on a value of an overall contract compliance metric.

14. The computer program product of claim 13 wherein the method further comprises validating the heat map by providing heat map data to a validation tool.

15. Apparatus for monitoring subcontractor compliance risk, the apparatus comprising:
means for assaying tiering criteria for each subcontractor from among a plurality of subcontractors, the tiering criteria indicative of situational risk;
means for scoring each subcontractor by using results of the assaying for each of the tiering criteria to calculate a risk score for the subcontractor; and
means for assigning each subcontractor to a tier using a numerical value of the risk score, wherein the tier is indicative of a compliance risk monitoring posture for the subcontractor.

16. The apparatus of claim 15 further comprising means for aggregating contract element values for the plurality of subcontractors into a plurality of contract compliance metrics when the risk score is greater than a specified threshold value.

17. The apparatus of claim 16 further comprising means for displaying a heat map for the plurality of contract compliance metrics for the plurality of subcontractors, wherein the heat map contains visual highlighting based on a value of an overall contract compliance metric.

18. The apparatus of claim 17 further comprising means for providing heat map data to a validation tool.

19. A system for monitoring subcontractor compliance risk, the system comprising:
an instruction execution platform operable to assay tiering criteria indicative of situational risk for each subcontractor from among a plurality of subcontractors, score the subcontractor to calculate a risk score for the subcontractor, and assign the subcontractor to a tier using a numerical value of the risk score; and
a data set comprising contract element values and heat map data calculated by the instruction execution platform when the risk score is greater than a specified threshold value, the data set being disposed to be accessed by the instruction execution platform.

20. The system of claim 19 further comprising a display for displaying the heat map for a plurality of contract compliance metrics determined from the contract element values, wherein the heat map contains visual highlighting based on a value of an overall contract compliance metric.

21. The system of claim 19 further comprising a network connecting the instruction execution platform and the data set.

22. The system of claim 20 further comprising a network connecting the instruction execution platform and the data set.
